(19) United States
(12) Patent Application Publication
(10) Pub. No.: US 2021/0399337 A1
(43) Pub. Date: Dec. 23, 2021

(54) SOLID ELECTROLYTE MATERIAL WITH IMPROVED CHEMICAL STABILITY

(71) Applicant: Robert Bosch GmbH, Stuttgart (DE)

(72) Inventors: Joo Young Choi, Braunschweig (DE); Aslihan Oeruem Aydin, München (DE); Hyunchul Roh, Putzbrunn (DE)

(21) Appl. No.: 17/288,670

(22) PCT Filed: Oct. 21, 2019
(86) PCT No.: PCT/EP2019/078511

§ 371 Date: Apr. 26, 2021

(30) Foreign Application Priority Data
Oct. 25, 2018 (DE) 10 2018 218 262.0

(51) Int. Cl. H01M 10/0562; H01M 10/0525; H01M 50/431

(52) U.S. Cl. CPC H01M 10/0562; H01M 2300/0071; H01M 50/431; H01M 10/0525

(57) ABSTRACT

The invention relates to a solid electrolyte material (1) for an electrochemical cell (10), particularly a lithium ion battery cell, comprising: at least one garnet-type lithium ion-conducting solid electrolyte (2), and at least one coating material (3), which is applied to at least a part of the surface of the garnet-type lithium ion-conducting solid electrolyte (2), the at least one coating material (3) comprising at least one lithium ion-conducting compound, which is chemically stable against air and humidity. The invention further relates to a method for producing the solid electrolyte material (1), the use thereof, and an electrochemical cell (10) comprising the solid electrolyte material (1).

### BACKGROUND OF THE INVENTION

The invention relates to a solid electrolyte material and also a process for the production thereof.

Modern electrochemical cells, in particular for lithium ion battery cells, are increasingly being made as solid-state cells, i.e. they use solid electrolytes instead of liquid electrolytes. Such solid-state cells frequently comprise inorganic solid electrolytes. Compared to polymer electrolytes these possess a good lithium ion conductivity even at low temperatures, for example at room temperature.

Typical inorganic solid electrolytes are generally compounds based on sulfides or based on oxides. Promising representatives of oxidic solid electrolytes are compounds of the garnet type which have already been studied for use in electrochemical cells.

US 2017/179522 discloses lithium-filled garnet compounds which are doped with aluminum oxide, and also the use thereof as electrolyte in solid-state batteries.

US 2013/0260250 discloses a secondary battery which comprises a positive active material, a negative active material and an electrolyte material with, arranged between the electrolyte material and the positive active material, a modifying material which has a higher relative permittivity than the electrolyte material. This is intended to reduce the interfacial resistance between the positive active material and the electrolyte material.

### SUMMARY OF THE INVENTION

The invention provides a solid electrolyte material having improved chemical stability and also a process for the production thereof. The solid electrolyte can advantageously be used in electrochemical cells, in particular in lithium ion battery cells.

The invention also provides a solid electrolyte material for an electrochemical cell, in particular a lithium ion battery cell, comprising:

at least one lithium ion-conducting solid electrolyte of the garnet type,

and

at least one coating material which has been applied to at least part of the surface of the lithium ion-conducting solid electrolyte of the garnet type,

wherein the at least one coating material comprises at least one lithium ion-conducting compound which is chemically stable to air and moisture.

Lithium ion-conducting solid electrolytes of the garnet type are a promising group of compounds for use in electrochemical cells and display good ion conductivity combined with a low electrical conductivity and high stability to metallic lithium. In addition, solid electrolytes of the garnet type are stable over a wide range of electric potentials. However, it has been observed that when solid electrolytes of the garnet type are in contact with air they can undergo chemical reactions, e.g. with water or CO₂. This results in formation of undesirable reaction products having a low ion conductivity (e.g. LiOH, Li₂CO₃) which increase the interfacial resistance between the solid electrolyte and the electrodes. As a result of the coating proposed here, the solid electrolyte of the garnet type is provided with a chemically stable protective layer having good lithium ion conductivity, so that this electrolyte no longer comes into contact with air and no undesirable impurities having a low ion conductivity can thus be formed.

In principle, it is possible to use, as lithium ion-conducting solid electrolyte of the garnet type, any solid electrolyte of the garnet type known to a person skilled in the art. Preference is given here to at least one compound of the general formula Li_{y}A₃B₂O₁₂,

where
A is selected from at least one element of the group consisting of La, K, Mg, Ca, Sr and Ba, in particular La,
B is selected from at least one element of the group consisting of Zr, Hf, Nb, Ta, W, In, Sn, Sb, Bi and Te, in particular Zr and Ta,
and 3≤y≤7, in particular 5≤y≤7.

Suitable solid electrolytes of the garnet type usually have a predominantly cubic crystal structure.

Particularly preferred solid electrolytes of the garnet type are, in particular, lithium lanthanum zirconates (LLZO) of the formula Li₇La₃Zr₂O₁₂ and lithium lanthanum tantalates (LLTO) of the formula Li₇La₃Ta₂O₁₂.

The solid electrolyte of the garnet type is frequently present in the form of particles. Typical particles have an average particle diameter of from 1 nm to 1 mm, preferably from 100 nm to 100 μm and in particular from 0.5 μm to 10 μm. However, the solid electrolyte of the garnet type can in principle also be present in any other form, for example as contiguous body, e.g. as layer. Such embodiments are also encompassed by the teaching of the invention.

In order to protect the solid electrolyte of the garnet type against direct contact with air and moisture, at least one coating material which comprises at least one lithium ion-conducting compound which is chemically stable to air and moisture is applied to the surface of the electrolyte. For the purposes of the present invention, this means that the lithium ion-conducting compound undergoes essentially no chemical reactions with water and the usual constituents of air, in particular CO₂, O₂, N₂, H₂, CH₄, in a temperature range from 0° C. to 80° C., more preferably from 0° C. to 100° C. and in particular from 0° C. to 120° C.

In a preferred embodiment, the coating material comprises at least one compound selected from lithium halides, lithium borates, lithium aluminates, lithium zirconates and mixtures thereof as lithium ion-conducting compound which is chemically stable to air and moisture.

Examples of particularly suitable compounds which are chemically stable to air and moisture encompass LiF, LiCl, LiBr, Lil, Li₃BO₃, Li₂B₄O₇, LiBO₂, LiAlO₂, Li₅AlO₄, LiAl₅O₈, Li₂ZrO₃, Li₄ZrO₄ and mixtures thereof.

The coating material particularly preferably comprises at least one compound selected from LiF, Li₃BO₃, LiAlO₂ and Li₂ZrO₃, and also mixtures thereof.

In one embodiment of the invention, the coating material comprises at least LiF.

In an alternative embodiment of the invention, the coating material comprises at least Li₃BO₃.

In a further alternative embodiment of the invention, the coating material comprises at least LiAlO₂.

In a further alternative embodiment of the invention, the coating material comprises at least Li₂ZrO₃.

In a further alternative embodiment of the invention, the coating material comprises at least two compounds selected from LiF, Li₃BO₃, LiAlO₂ and Li₂ZrO₃.

The coating material can additionally comprise additives in order to exert a positive influence on the properties of the coating material. Suitable additives for increasing the mechanical stability of the coating material are, in particular, binders such as carboxymethyl cellulose (CMC), styrene-butadiene copolymer (SBR), polyvinylidene fluoride (PVDF), polytetrafluoroethene (PTFE), polyacrylonitrile (PAN) and ethylene-propylene-diene terpolymer (EPDM).

The coating material comprises at least one lithium ion-conducting compound which is chemically stable to air and moisture. The entire coating material is preferably chemically stable to air and moisture.

In a preferred embodiment, the coating material consists of the at least one compound which is chemically stable to air and moisture.

The at least one compound which is chemically stable to air and moisture is preferably also chemically stable to elemental lithium in a temperature range from 0° C. to 80° C., preferably in a temperature range from 0° C. to 100° C. and in particular in a temperature range from 0° C. to 120° C.

The entire coating material is preferably chemically stable to elemental lithium in a temperature range from 0° C. to 80° C., preferably in a temperature range from 0° C. to 100° C. and in particular in a temperature range from 0° C. to 120° C.

The coating material is applied to at least part of the surface of the lithium ion-conducting solid electrolyte of the garnet type. The layer thickness of the layer composed of the coating material on the surface of the lithium ion-conducting solid electrolyte of the garnet type is preferably in a range from 10 nm to 1000 nm, more preferably in a range from 15 nm to 500 nm and in particular in a range from 20 nm to 200 nm. Such a layer thickness is sufficient to prevent contact between the air and lithium ion-conducting solid electrolyte of the garnet type.

In a particularly preferred embodiment, the entire surface of the lithium ion-conducting solid electrolyte of the garnet type is provided with a coating composed of the coating material.

The invention also provides a process for producing a solid electrolyte material according to the invention, wherein the process comprises at least the following process steps:
(i) provision at least one lithium ion-conducting solid electrolyte of the garnet type,
(ii) provision of at least one coating material comprising at least one lithium ion-conducting compound which is chemically stable to air and moisture and
(iii) application of the coating material to at least part of the surface of the lithium ion-conducting solid electrolyte of the garnet type.

As regards the selection of suitable materials for the lithium ion-conducting solid electrolyte of the garnet type and for the coating material, what has been said above applies.

In a first process step (i), a lithium ion-conducting solid electrolyte of the garnet type is provided. Provision can be effected, for example, in the form of particles or in the form of a contiguous body, for example a layer. A contiguous body can, for example, be obtained by sintering of individual particles.

In a second process step (ii), the coating material is provided. For this purpose, a mixture of the at least one lithium ion-conducting compound which is chemically stable to air and moisture and the optional additives, in particular binders, is preferably produced. In addition, it can be necessary to add a solvent to the coating material if such addition is required by the process selected in process step (iii) for applying the coating material to at least part of the surface of the lithium ion-conducting solid electrolyte of the garnet type.

Suitable solvents are able to dissolve the at least one lithium ion-conducting compound which is chemically stable to air and moisture, and are preferably free of water and air.

In a third process step (ii), the coating material provided is applied to at least part of the surface of the lithium ion-conducting solid electrolyte of the garnet type. The coating material provided is preferably applied to the entire surface of the lithium ion-conducting solid electrolyte of the garnet type.

The application can be carried out by means of any process which is known to a person skilled in the art and is suitable for this use. Suitable processes encompass, in particular, physical vapor deposition (PVD) processes, chemical vapor deposition (CVD) processes, spray processes and/or sputtering processes.

If a solvent has been used for application of the coating material, this is preferably removed in a further process step (iv) immediately after the process step (iii). Said removal can, in particular, be carried out at elevated temperature and/or under reduced pressure.

In a particularly preferred embodiment of the process of the invention, this is entirely or partly carried out in the absence of water and air. It is preferable that all of the process steps (i) to (iii) are carried out in the absence of water and air. In such cases the process is preferably carried out in a water-free inert gas atmosphere, for example in an atmosphere composed of N₂ and/or Ar.

The invention also provides for the use of a solid electrolyte material according to the invention in an electrochemical cell, in particular in a lithium ion battery cell. The solid electrolyte material of the invention can preferably be used in a separator and/or in an electrolyte.

The invention thus also encompasses a separator for an electrochemical cell, which separator comprises or consists of at least one solid electrolyte material according to the invention.

The invention also encompasses an electrolyte for an electrochemical cell, which electrolyte comprises or consists of at least one solid electrolyte material according to the invention. The electrolyte can preferably be used in direct contact with a negative electrode active material and/or a positive electrode active material.

The invention also provides an electrochemical cell comprising at least one solid electrolyte material according to the invention or at least one solid electrolyte material obtained by the process of the invention.

The electrochemical cell of the invention usually comprises at least one negative electrode according to the invention, at least one positive electrode, at least one separator and at least one electrolyte.

The negative electrode of the electrochemical cell of the invention (also referred to as anode) comprises at least one active material which comprises elemental lithium, carbon derivatives such as graphite or amorphous carbon, silicon, in particular nanocrystalline, amorphous silicon, and/or lithium titanate (Li₄Ti₅O₁₂). In a preferred embodiment, the active material of the negative electrode comprises elemental lithium. The active material can, if necessary, be present in the form of an active material composition which comprises at least one binder in addition to the active material. Suitable binders are, in particular, carboxymethyl cellulose (CMC), styrene-butadiene copolymer (SBR), polyvinylidene fluoride (PVDF), polytetrafluoroethene (PTFE), polyacrylonitrile (PAN) and ethylene-propylene-diene terpolymer (EPDM).

The negative electrode additionally comprises at least one current collector. This comprises at least one electrically conductive material, in particular a metal. Particularly preferred metals are copper, lithium, nickel, aluminum, iron and also alloys of these metals with one another or with other metals. In one embodiment of the invention, both the active material and the current collector of the negative electrode consist of lithium.

The positive electrode of the electrochemical cell of the invention (also referred to as cathode) comprises at least one active material composition and at least one current collector. The current collector is made of an electrically conductive material, in particular a metal, preferably aluminum.

The active material composition of the positive electrode can in principle comprise any cathode active material known to a person skilled in the art which is suitable for producing lithium ion batteries. Suitable cathode active materials which may be emphasized are sheet oxides such as lithium nickel cobalt aluminum oxides (NCA; e.g. LiNi_{0.8}Co_{0.15}Al_{0.05}O₂), lithium nickel cobalt manganese oxides (NCM; e.g. LiNi_{0.8}Mn_{0.1}Co_{0.1}O₂) (NMC (811)), LiNi_{0.33}Mn_{0.33}Co_{0.33}O₂ (NMC (111)), LiNi_{0.5}Mn_{0.3}Co_{0.2}O₂ (NMC (532)), LiNi_{0.6}Mn_{0.2}Co_{0.2}O₂ (NMC (622)), or high-energy lithium nickel cobalt manganese oxides (superlithiated lithium nickel cobalt manganese oxides), LiCoO₂, olivines such as lithium iron phosphate (LiFePO₄, LFP), lithium manganese phosphate (LMP) or lithium cobalt phosphate (LCP), spinels such as LiMn₂O₄, Li₂MnO₃, Li_{1.17}Ni_{0.17}Co_{0.1}Mn_{0.56}O₂ or LiNiO₂, lithium-rich cubic crystal systems (face centered cubic or FCC) such as Li₂MO₂F (where M=V, Cr), conversion materials such as FeF₃, and sulfur-containing materials such as SPAN.

In addition, the active material composition of the positive electrode preferably comprises at least one binder and/or electrically conductive additive in order to increase the stability and electrical conductivity. Suitable binders are, in particular, carboxymethyl cellulose (CMC), styrene-butadiene copolymer (SBR), polyvinylidene fluoride (PVDF), polytetrafluoroethene (PTFE), polyacrylonitrile (PAN) and ethylene-propylene-diene terpolymer (EPDM). Suitable electrically conductive additives which may be mentioned are conductive carbon black, graphite and carbon nanotubes.

The electrochemical cell of the invention additionally comprises at least one separator. The separator serves to protect the electrodes from direct contact with one another and thus to prevent a short circuit. At the same time, the separator must ensure transfer of the ions from one electrode to the other. In one embodiment of the invention, the separator comprises the solid electrolyte material of the invention or consists of this. As an alternative, the separator can be made of a conventional separator material, in particular a polymer such as cellulose, polyolefins, polyesters and fluorinated polymers. Preferred polymers are cellulose, polyethylene (PE), polypropylene (PP), polyethylene terephthalate (PET), polytetrafluoroethene (PTFE) and polyvinylidene fluoride (PVdF).

In addition, the electrochemical cell comprises at least one solid electrolyte. As solid electrolyte, preference is given to using the solid electrolyte material of the invention. As an alternative or in addition, a known electrolyte can also be used.

If a solid electrolyte is used in the electrochemical cell, the use of an additional separator can generally be dispensed with. In this case, the solid electrolyte is arranged between the at least one negative electrode and the at least one positive electrode and separates these from one another. The solid electrolyte thus assumes the function of the separator and of the electrolyte. The solid electrolyte in this case preferably comprises the solid electrolyte material of the invention.

The electrochemical cell of the invention can advantageously be used in an electric vehicle (EV), in a hybrid vehicle (HEV), in a plug-in hybrid vehicle (PHEV), in a tool or in a consumer electronics product. Here, tools are, in particular, household tools and garden tools. Consumer electronics products are, in particular, mobile telephones, tablet PCs or notebooks.

The solid electrolyte material of the invention is characterized in that it overcomes the disadvantageous reactivity of lithium ion-conducting solid electrolytes of the garnet type toward moisture and air and thus suppresses the formation of undesirable impurities on the surface of the solid electrolyte. In addition, the coating with a coating material which comprises at least one lithium ion-conducting compound which is chemically stable to air and moisture reduces the interfacial resistance between the solid electrolyte material and the active material of the electrode.

Furthermore, the stability of the solid electrolyte material to elemental lithium can be increased in this way and undesirable reactions between elemental lithium from the active material of the negative electrode and the lithium ion-conducting solid electrolyte of the garnet type can be suppressed.

### BRIEF DESCRIPTION OF THE DRAWINGS

Embodiments of the invention will be explained in more detail with the aid of the drawings and the following description.

The drawings show:

FIG. 1 a schematic depiction of a solid electrolyte material according to the invention and

FIG. 2 a schematic depiction of an electrochemical cell according to the invention.

### DETAILED DESCRIPTION

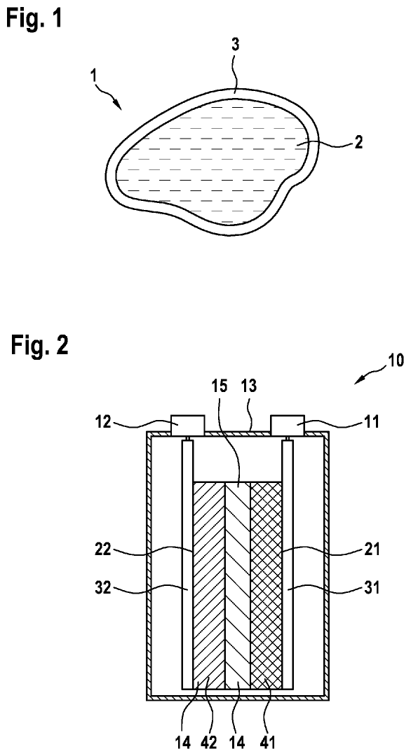

FIG. 1 schematically depicts a solid electrolyte material 1, in the present case in the form of a core/shell particle. The core of the solid electrolyte material 1 is composed of a lithium ion-conducting solid electrolyte 2 of the garnet type, for example Li₇La₃Zr₂O₁₂ or Li₇La₃Ta₂O₁₂. Applied on the surface of the solid electrolyte material 1 is a coating material 3 comprising at least one lithium ion-conducting compound which is chemically stable to air and moisture; this forms the shell of the core-shell particle. This coating material 3 comprises, for example, at least one compound selected from LiF, Li₃BO₃, LiAlO₂ and Li₂ZrO₃. The solid electrolyte material 1 can subsequently be used, for example, as electrolyte and/or separator in an electrochemical cell 10.

FIG. 2 schematically depicts the structure of an electrochemical cell 10. A current collector 31 contacts a negative electrode 21 and connects it to the negative terminal 11. On the opposite side, there is a positive electrode 22 which is likewise electrically connected to a current collector 32 for conduction to the positive terminal 12. The negative electrode 21 and the positive electrode 22 are arranged in a cell housing 13. The separator 15 mechanically separates the negative electrode 21 and the positive electrode 22 from one another. At the negative electrode 21, a lithium foil is used as active material 41 and is electrically connected to the current collector 31, e.g. made of copper. The positive electrode 22 comprises an active material composition which comprises at least one active material 42, for example a nickel manganese cobalt mixed oxide such as LiNi_{0.8}Mn_{0.1}Co_{0.1}O₂ (NCM (811)), and optionally conductive carbon black, binders and/or an electrolyte 14.

The solid electrolyte material 1 according to the invention can in the present case be used, in particular, in the separator 15 which at the same time performs the task of the electrolyte 14. As an alternative or in addition, the solid electrolyte material 1 according to the invention can also be used as electrolyte 14 in the positive electrode 22.

The invention is not restricted to the working examples described here and the aspects emphasized therein. Rather, many modifications of the kind that a person skilled in the art would carry out are possible within the scope indicated by the claims.

1. A solid electrolyte material (1) for an electrochemical cell (10), the solid electrolyte material (1) comprising:
at least one lithium ion-conducting solid electrolyte (2) of the garnet type, and
at least one coating material (3) which has been applied to at least part of a surface of the lithium ion-conducting solid electrolyte (2) of the garnet type,
wherein the at least one coating material (3) comprises at least one lithium ion-conducting compound which is chemically stable to air and moisture.

2. The solid electrolyte material (1) as claimed in claim 1, wherein the at least one lithium ion-conducting solid electrolyte (2) of the garnet type is a compound of the general formula Li_{y}A₃B₂O₁₂,
where
A is selected from at least one element of the group consisting of La, K, Mg, Ca, Sr and Ba,
B is selected from at least one element of the group consisting of Zr, Hf, Nb, Ta, W, In, Sn, Sb, Bi and Te, and
3≤y≤7.

3. The solid electrolyte material (1) as claimed in claim 1, wherein the at least one lithium ion-conducting compound which is chemically stable to air and moisture is selected from lithium halides, lithium borates, lithium aluminates, lithium zirconates and mixtures thereof.

4. The solid electrolyte material (1) as claimed in claim 1, wherein the at least one lithium ion-conducting compound which is chemically stable to air and moisture is selected from LiF, LiCl, LiBr, Li₃BO₃, Li₂B₄O₇, LiBO₂, LiAlO₂, Li₅AlO₄, LiAl₅O₈, Li₂ZrO₃, Li₄ZrO₄ and mixtures thereof.

5. The solid electrolyte material (1) as claimed in claim 1, wherein the coating material (3) composed of the at least one lithium ion-conducting compound which is chemically stable to air and moisture has been applied in the form of a layer having a layer thickness of from 10 nm to 1000 nm to at least part of the surface of the lithium ion-conducting solid electrolyte (2) of the garnet type.

6. A process for producing a solid electrolyte material (1) as claimed in claim 1, wherein the process comprises at least the following process steps:
(i) provision at least one lithium ion-conducting solid electrolyte (2) of the garnet type,
(ii) provision of at least one coating material (3) comprising at least one lithium ion-conducting compound which is chemically stable to air and moisture and
(iii) application of the coating material (3) to at least part of the surface of the lithium ion-conducting solid electrolyte (2) of the garnet type.

7. The process as claimed in claim 6, wherein the process is carried out in the absence of water and air.

8. (canceled)

9. (canceled)

10. An electrochemical cell (10) comprising at least one solid electrolyte material (1) as claimed in claim 1.

11. A lithium ion battery cell comprising a solid electrolyte material (1) as claimed in claim 1.

12. The electrochemical cell (10) as claimed in claim 10, wherein the solid electrolyte material (1) is a separator (15).

13. The electrochemical cell (10) as claimed in claim 12, wherein the solid electrolyte material (1) is an electrolyte (14).

14. The electrochemical cell (10) as claimed in claim 10, wherein the solid electrolyte material (1) is a separator (15) and an electrolyte (14).
